(19) United States
(12) Patent Application Publication
(10) Pub. No.: US 2021/0358061 A1
(43) Pub. Date: Nov. 18, 2021

(54) SERVER-CLIENT SYSTEM FOR STANDARDIZING A QUANTITY WORK REQUIRED TO PREPARE AN ASSET FOR A TRANSACTION

(71) Applicant: JetClosing Inc., Seattle, WA (US)

(72) Inventors: Eric T. Bloomquist, Seattle, WA (US); Andrew D. Greenshields, Seattle, WA (US); Shawna J. Hernandez, Seattle, WA (US); Arthur C. Delight, IV, Seattle, WA (US); Xiaodi Huang, Seattle, WA (US); Samuel Levine, Seattle, WA (US); Nate Eisele, Sammamish, WA (US); David Wolf, Redmond, WA (US)

(21) Appl. No.: 16/874,989

(22) Filed: May 15, 2020

(51) Int. Cl. G06Q 50/16; G06F 16/29; G06Q 30/06

(52) U.S. Cl. CPC G06Q 50/167; G06Q 30/0627; G06Q 30/0643; G06F 16/29

(57) ABSTRACT

A server-client architecture including a host server and a client device. The client device executes a client application that communicably couples to the host server. The host server is configured to receive an input including information related to a particular asset, such as a real property. The host server is configured to access one or more third party databases to enumerate encumbrances upon a seller's title to the particular asset and, in response, generate a grading of a property based on, without limitation, the (1) number and (2) type of encumbrances identified by the third party databases. The grading is thereafter transmitted to the client device for display to a user of the client device.

### TECHNICAL FIELD

Embodiments described herein relate to network architectures for securely transacting information across computer networks and, in particular, to systems and methods for quantifying and/or standardizing an evaluation or estimation of work required to prepare an asset for a transaction, such as a purchase transaction.

### BACKGROUND

Parties to a transaction to sell an asset may exchange various documents, data, or information prior to closing the transaction to ensure that all agreed-upon conditions to the transaction have been met by all parties and to ensure that a seller possesses marketable title to that asset. In many cases, collecting, validating, organizing, and/or distributing information between parties is time-consuming and expensive because, among other things, rules and requirements for disclosure between parties vary substantially by transaction type and jurisdiction. Further, in many cases, undisclosed, unknown, or undiscovered encumbrances upon (or errors effecting) the seller's title may expose a lender or a party to potential losses or liabilities. As a result, comprehensive title searches are often necessary to ensure that the seller of an asset, such as real or personal property, has a marketable title to that asset.

However, conventional methods of conducting comprehensive chain of title searches and completing other evaluations of a seller's title are time consuming and inefficient at least insofar as enumerating all title curative issues attached to an asset is a substantially manual and labor-intensive process subject to human error.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A illustrates an embodiment of a system, such as described herein.

FIG. 1B illustrates an embodiment of an event-driven architecture of a system, such as described herein.

FIG. 1C illustrates an embodiment of an asset grading system, such as described herein.

FIG. 2 depicts an example user interface associated with an automated evaluation system, such as described herein.

FIG. 3 depicts another example user interface associated with an automated evaluation system, such as described herein.

FIG. 4 depicts another example user interface associated with an automated evaluation system, such as described herein.

FIG. 5 depicts another example user interface associated with an automated evaluation system, such as described herein.

FIG. 6 depicts another example user interface associated with an automated evaluation system, such as described herein.

FIG. 7 depicts another example user interface associated with an automated evaluation system, such as described herein.

FIG. 8 depicts another example user interface associated with an automated evaluation system, such as described herein.

FIG. 9 depicts another example user interface associated with an automated evaluation system, such as described herein.

FIG. 10 depicts another example user interface associated with an automated evaluation system, such as described herein.

FIG. 11 depicts another example user interface associated with an automated evaluation system, such as described herein.

FIG. 12 depicts another example user interface associated with an automated evaluation system, such as described herein.

FIG. 13 depicts another example user interface associated with an automated evaluation system, such as described herein.

FIG. 14 depicts another example user interface associated with an automated evaluation system, such as described herein.

FIG. 15 depicts another example user interface associated with an automated evaluation system, such as described herein.

FIG. 16 depicts another example user interface associated with an automated evaluation system, such as described herein.

FIG. 17 depicts another example user interface associated with an automated evaluation system, such as described herein.

FIG. 18 illustrates an embodiment of a scoring method 1800.

FIG. 19 illustrates an embodiment of a scoring update method 1900.

FIG. 20 illustrates an embodiment of a timed update method 2000.

FIG. 21 illustrates an embodiment of a detected update method 2100.

FIG. 22 illustrates a system in accordance with one embodiment.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein reference systems and methods for facilitating a close of a transaction between two or more parties in a specific jurisdiction enforcing specific rules, regulations, and/or requirements. In particular, embodiments described herein reference systems and methods for aggregating data, and monitoring for changes in that aggregated data, to automatically and in substantially real time determine how much work may be associated with perfecting a seller's title to a given asset. More particularly, the “work” associated with perfecting a seller's title may include (1) enumerating and/or eliminating encumbrances to that seller's title (e.g., liens, joint owners, and so on) and (2) enumerating and/or correcting errors present in the seller's title (e.g., misspellings, incorrect information, and so on).

A system such as described herein can be configured to aggregate and analyze such data (which may be collected from third party resources or data sources), and updates to such data, to generate a normalized or otherwise standardized “grading” of a particular asset that is the subject of a particular transaction. In this manner, an automatically generated and autonomously updated grading can be used by parties to transactions to evaluate and/or otherwise classify different potential transactions based on a prediction of transaction costs. In one specific and non-limiting example, a buyer seeking to purchase real property can leverage an automated grading such as described herein to prioritize transactions having a higher grading because, at least in part, such properties may be associated with lower transaction costs.

Phased in another, non-limiting manner, a system such as described herein can automatically generate grades of potential assets, said grades based at least in part on automatically-determined encumbrances upon or errors with a seller's title to the asset that is the subject of a given transaction; the more encumbrances and/or errors that are discovered that turn against a seller's marketable title, the lower the grading of that asset may be. Conversely, the fewer encumbrances and/or errors that are discovered against a seller's marketable title, the higher the grading of that asset may be. In this manner, systems such as described herein can be leveraged to quickly identify low transaction cost and/or low complexity transactions (properties with high grades and sellers having marketable, unencumbered title) and separate such more desirable transactions from higher transaction costs and/or high complexity transactions (e.g., properties with low grades and sellers having encumbered or incomplete title).

As noted above, an example of an asset, such as described herein, is real property. However, this is merely one example of an asset that may be the subject of a transaction such as described herein. Other examples include, but are not limited to: personal property; entities; securities; and so on. For simplicity of description, the embodiments that follow reference a “real property transaction” as one example of a transaction; it may be appreciated that this is merely one example.

It may be appreciated that a private real estate transaction is merely one example and that the various techniques, examples, methods, network architectures, data structures, and systems described herein can be equivalently applied to facilitate other transactions or transaction types including, but not limited to: commercial real estate transactions; insurance purchase transactions (e.g., automotive, health, liability, travel, corporate, business, gap, life, co-insurance, and so on); personal property purchase transactions; asset purchase agreements; and so on. For simplicity of description, however, the embodiments described herein reference real property transactions and requirements related to a private real estate transaction.

In particular, described herein are systems and methods for displaying information related to real property grades on client applications operating on end-user electronic devices (e.g., laptop computers, desktop computers, tablet computers, cellular phones, and so on) in communication with a centralized host server or service configured to automatically collect information and aggregate information related to said properties and, additionally, configured to automatically determine grades for those properties based on the collected information. For example, a real property grade may be presented as a graduated scale including A, B, C, D, and F. In this example, the host server can be configured to communicably coupled to one or more third-party databases to enumerate encumbrances upon a given property; the higher the number of encumbrances (and/or the type of those encumbrances) may inform whether the property is assigned a grade A or a grade F. In one example, the host service may determine by querying a lien database with the address or parcel number of the property that a given property is subject to two mortgages. Such a property may be graded lower (e.g., A−) than a property without any liens (e.g., A+). In further examples, as described below, a property that is the subject of a lawsuit or that is subject to an existing lease may be graded lower than a property that has a single public easement. In yet another examples, a multi-family property subject to 20 separate leases may be graded lower than a single property of equivalent value that has a single mechanic's lien. In other cases, a coupon clipper property with full tenancy and multiple multi-year leases may be graded higher than a similar property with vacancies (e.g., because multi-year leases with reliable tenants may increase value of a property in the view of a buyer). In other cases, multiple leases may be graded lower due to administrative challenges associated with transitioning those leases. It may be appreciated that the foregoing examples are not exhaustive; a host server such as described herein can appropriately determine any suitable grading for any suitable property in any suitable manner. The form taken by a grading, such as described herein can likewise take any suitable form (e.g., numeric range, graduated scale, color code, and so on).

In still further embodiments, a host service such as described herein can be configured to analyze information provided by a seller of real property (or any other suitable asset) to adjust a grading of that property. For example, the seller may provide information that one or more liens to the property have been released. In these examples, the host server can be configured to increase or decrease a reported grade of a given property based on information provided by the seller and/or the seller's agent.

More generally and broadly, embodiments described herein reference a network architecture including a host service and a client device. The host service can be implemented in any suitable manner as one or more client-server architecture applications supported by one or more physical servers, network appliances, and/or storage appliances (each of which may include, without limitation: a processor; memory; storage; network connections; and so on) or, additionally or alternatively, supported by a virtual server or container virtualized or containerized in whole or in part in a virtual computing environment. In some cases, the host service can be implemented, in whole or in part, as a cloud service operating on a number of physical servers that may or may not be geographically distributed.

The host service (including any modules, components, plugins, and so on thereof) can be configured to communicably couple to one or more instances of a client application executed, at least in part, by one or more client devices. Each instance of a client application, such as described herein, may be associated with, or otherwise accessible to, one or more parties to a private real estate transaction (e.g., buyer, seller, agents, broker, attorney, lender, inspector, appraiser, insurance provider, and so on). A client device, such as described herein—that may be configured to operate (or execute) an instance of the client application—can be any suitable portable or stationary electronic device including, without limitation: a personal computer (e.g., desktop, laptop, and so on) or a mobile wireless terminal (e.g., a cell phone, tablet, and so on).

The host service and multiple instances of the client application are configured to securely exchange and display information related to one or more real property transactions, including property grades.

It may be appreciated that the preceding examples are not exhaustive and that, generally and broadly, a host service, such as described herein, functions to collect, aggregate, and/or distribute data, documentation, or information (herein, simply, “information”) received from, and/or requested of, one or more instances of a client application to facilitate a close of a real property transaction. Similarly, it may be appreciated that a grading such as described herein can be determined from any suitable source material (e.g., third party databases, municipal database, direct seller or buyer input, and so on). In some cases, a grading may be based on information provided by a buyer; in such examples, a grading of a given property may be buyer-specific and/or may be tailored to a buyer's preference, budget, settings, sophistication, or lender-imposed limitations. These examples are not exhaustive; it may be appreciated that generally and broadly a buyer and/or a seller may provide information that influences a grading of a particular property generated automatically by a system such as described herein.

Example information that can be exchanged between an instance of client application—operated by any suitable entity or individual associated with, or performing, any suitable role in a given or selected real property transaction—and a host service, such as described herein, can include, but may not be limited to: a legal and/or mailing address of real property; buyer name; seller name; buyer agent name and/or contact information; seller agent name and/or contact information; parcel description; property description; property tax information; earnest money deposit information; escrow account information; appraisal documentation; inspection documentation (e.g., home, pest, structural, environmental, government mandated, and so on); inspection report information; inspection objection information; insurability information; insurance information; contingency information; pre-approval or financing commitment letters or information; verification of payment or proof of funds information; common interest community documents; homeowners association documents or information; party wall agreements or information; public or private easement information; report information; loan or financing information; lender information; borrower information; seller disclosure information; executed approvals or disclosures; title insurance information; title commitment information; private mortgage insurance information; waiver information; and so on, or any combination thereof.

In addition, as noted above, the type, form, format, and/or detail level of information required to be exchanged between parties to a real property transaction (and/or third parties), may vary from jurisdiction to jurisdiction. For example, a first jurisdiction may require environmental inspections and/or disclosures (e.g., lead paint disclosures, friable asbestos disclosures, flood disclosures, stigmatized property disclosures, and so on) while a second jurisdiction may not. In another example, a first jurisdiction may require water or mineral rights agreements or disclosures while a second jurisdiction may not. In yet other examples, different jurisdictions may identify, or refer to, the same or similar information, documents, or document types with different terminology. For example, a first jurisdiction may refer to a contract to buy or sell real estate as a “sales contract” while a second jurisdiction refers to the same document by a form number. In still other examples, different jurisdictions may require documents or information to be exchanged, presented, or filed in a different order. As such, in view of the non-exhaustive foregoing examples, it may be appreciated that, generally and broadly, the process of closing escrow may vary, substantially, from jurisdiction to jurisdiction. Further, it may be appreciated that the same encumbrance type may be graded differently in different jurisdictions. In one jurisdiction, a mechanics lean may be more administratively cumbersome to remove than in another jurisdiction—thus, a property with a mechanics lien in the first jurisdiction may be graded lower than a property with a mechanics lien in the second jurisdiction.

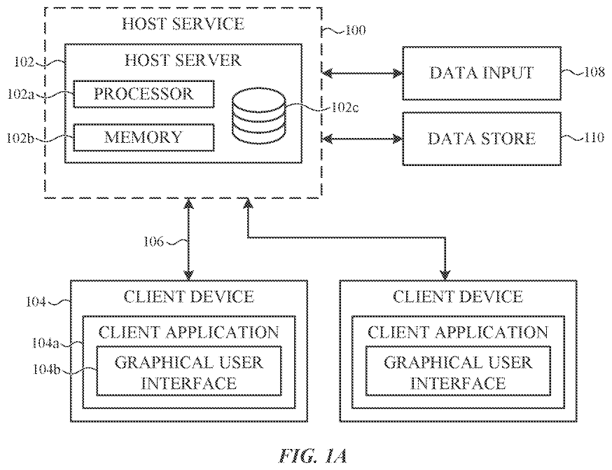

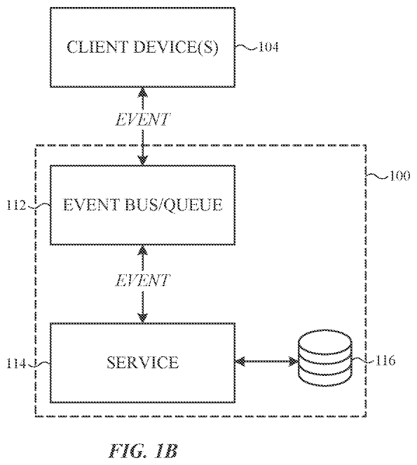

These and other embodiments are described below with reference to FIGS. 1A-22. It may be appreciated, however, that these examples and embodiments are not exhaustive of the various systems and methods that may be implemented or practiced in view of the disclosure provided herein.

FIG. 1A depicts an example system, such as described herein. The system includes a host service 100 that may be provided by or otherwise hosted by a host server 102. The host server 102 may be implemented or allocated in any suitable manner, whether virtual or physical or a combination thereof. The host service 100 may be implemented as a virtual machine or container, in certain embodiments. In other examples, the host service 100 can be implemented as a cluster or grouping of virtual, physical, or containerized purpose-configured resource allocations (e.g., processors such as the processor 102a, memory such as the memory 102b, and/or data store(s) such as the data store 102c, and so on). It may be appreciated, more generally and broadly the host service 100 and/or the host server 102 serving the host service 100 can be implemented in a number of suitable ways.

The host service 100 can be communicably coupled to one or more client devices, one of which is identified as the client device 104, that, like the host server 102, can be implemented with physical or virtual resources, such as with processors, memory, data stores, displays, and the like. Example client devices include but are not limited to: cell phones; desktop computers; servers; server platforms; software as service platforms; embedded systems; tablet computers; and so on. In many embodiments, as noted above, a client device can be configured to instantiate a client application 104a that, in turn, renders a graphical user interface 104c. The graphical user interface 104c can be configured to provide information to a user of the client device 104 that may be a party to a real estate transaction, such as described herein. In such examples, the graphical user interface can be used to display property grades, such as described herein.

The client application instantiated by a client device (such as the client device 104) can be communicably coupled to the hos service via a communications channel 106 (e.g., wired or wireless network, which may include the open Internet).

The host service 100 can be further communicably coupled to one or more data input sources such as an input resource 108 and a data store 110. The host service 100 can be configured to retrieve information from either or both the input resource 108 and/or the data store 110 in order to inform a grading determination relative to a particular property or, in some cases, to provide information to be displayed via a graphical user interface of a client device, such as the graphical user interface 104a.

In many embodiments, the client device and the host service may be configured to implement a request-response architecture. In many cases, however, a system, such as described herein, can be implemented with any number of suitable communications architectures. For example, although many embodiments described herein reference a request-response architecture, it may be appreciated that this is merely one example. More specifically, in other embodiments, such as shown in FIG. 1B, an event-driven architecture can be used. In particular the system depicted in FIG. 1B shows a host service 100 communicably coupled to a client device 104. The host server includes an event bus 112 (also referred to as an event dispatch, an event queue, a message queue, or any other suitable similar phrase). The event bus 112 is configured to asynchronously receive and store discrete data items referred to as “events” formatted according to a specification or protocol unique to the system and/or conforming with a specified messaging protocol. In this example, the event bus 112 can receive events from the client device 104 and store those events in a queue based on a time stamp or indexed order in which each event was received and/or added to the event bus 112. Thereafter, events stored by the event bus 112 can be consumed by one or more services, servers, microservices, functions, lambda functions, and so on associated with an operation or task of the host service 100.

Collectively, these example event-consuming elements are depicted in FIG. 1B as the event bus 114. The event bus 114 can receive and/or consume events and/or be notified of new events from the event bus 112 in any suitable manner. Examples include, but are not limited to: registering the event bus 114 as a callback executed by the event bus 112 once an event of a given type is received; registering the event bus 114 as a subscriber of a particular message type generated by the event bus 112 in response to the event bus 112 receiving an event of a particular type or an event that changes a particular state; registering the event bus 112 as a subscriber of one or more announcements of state changes or events periodically generated or broadcast by the event bus 112; and so on. In some embodiments, the service 114 can include or can be coupled to a state database 116 that locally stores partial or complete state information or event information, at least partially mirroring information contained/stored by the event bus 112.

The foregoing example communication architecture is not exhaustive of the various types of communication(s) that can be implemented to exchange and/or process information through a system, such as described herein. As such, it may be appreciated that, generally and broadly and regardless of architecture or implementation, a system such as described herein is configured to cause one or more client devices executing the same client application to self-configure and display different information based on a configuration file, schema, or other instruction.

Referring to FIG. 1C, an asset grading system 100 comprises a client device 104, a host server/service 102, a one or more external control memory structures 118a, a grading processor 124, a resource effect control memory structure 126, a grade control memory structure 118b, an update timer 120, and a change detector 122.

The client device 104 receives a property information message, an update message, a user message, and a display message (or an updated display message). The property information message, the update message, and the user message may be input to the client device 104 via input devices configured to receive audio, text, haptic inputs, files, etc. The client device 104 receives the display message and transforms the display message into a visual display.

The client device 104 displays information associated with the grade control message determined by the asset grading system 100, as well as information associated with the external grading resources. The client device 104 may transform the property information message and the update message, and send those input messages to the host server/service 102. The client device 104 may display one or more activation controls on the machine display to receive the input.

The client device 104 may display the one or more activation controls in response to receiving a location, such as an input of a zip code, a control message from a device including GPS coordinates, detection of a geofence, etc. The client device 104 may also display one or more display activation controls based on the display message received, the one or more display activation controls operable to receive an update message.

The host server/service 102 receives the inputs (the property information message, the update message, and the user message) from the client device 104, the external grading resources from the one or more external control memory structures 118a, an update message from the update timer 120, a grade control message from the grade control memory structure 118b, and a detected change message from the change detector 122.

The host server/service 102 may utilize the property information message to determine the external grading resources for evaluation. The host server/service 102 may also determine whether the property information message has been associated with the grade control memory structure 118b. The host server/service 102 also determines an update time period. The host server/service 102 may utilize machine-based learning techniques to determine effects of the external grading resources and update those one or more resource effects in the resource effect control memory structure 126.

The one or more resource effects may also be determined by a location associated with the property information message. The host server/service 102 may also determine update time periods for each of the one or more external control memory structures 118a. This may be based on collected information regarding whether a resource control message prompted by a control message from the update timer 120 results in an update to the grade control message.

The host server/service 102 converts the grade control message to the display message and sends the display message (or updated display message) to the client device 104, a resource control message to the one or more external control memory structures 118a, a grade control message request message to the grade control memory structure 118b, an update time period message and a grade time stamp to the update timer 120, and a control message to the change detector 122. The display message may operate the client device 104 to display one or more display activation controls configured to receive an update message associated with one or more of the external grading resources. For example, one of the one or more external grading resources may not be present in the one or more external control memory structures 118a. One of the one or more display activation controls may enable the external grading resource to be input to the client device 104, which may send the external grading resource as an update message.

The one or more external control memory structures 118a receives a resource control message from the host server/service 102 and a control message from the change detector 122. The one or more external control memory structures 118a comprises external grading resources, which may be sent to the host server/service 102 in response to a resource control message. The one or more external control memory structures 118a may also send a control message to the change detector 122 in response to an alteration of external grading resources in the one or more external control memory structures 118a for which the change detector 122 has sent a control message to detect a change.

The grading processor 124 receives external grading resources from the host server/service 102, one or more resource effects from the resource effect control memory structure 126, and previously stored grade control messages from the grade control memory structure 118b. In response to receiving the external grading resources from the host server/service 102, the grading processor 124 may send a control message to retrieve stored grade control messages in the grade control memory structure 118b. The grading processor 124 also sends a control message to the resource effect control memory structure 126 to retrieve the one or more resource effects from the resource effect control memory structure 126 associated with the external grading resources received from the host server/service 102. The grading processor 124 transforms the one or more resource effects associated with the external grading resources into a grade control message. The one or more resource effects may be valued on a grading scale (e.g., A, B, C, etc.) or numerical ranking to determine the relative effect of one of the external grading resources to another. The grading processor 124 may determine the grade control message based on the highest relative effect, the lowest relative effect, or an average effect (which may be a weighted average). The grade control message may also be altered based on the number of the one or more resource effects at a particular ranking. The grade control message may be expressed as a grading scale (e.g., A, B, C, etc.) or numerical ranking when displayed. The grading processor 124 sends the grade control message to the grade control memory structure 118b. These processes may be performed in accordance with Listing (1).

The resource effect control memory structure 126 receives a control message from the grading processor 124 to send the one or more resource effects associated with the external grading resources received by the grading processor 124. The resource effect control memory structure 126 determines the one or more resource effects to be sent to the grading processor 124 and sends those one or more resource effects to the grading processor 124.

The grade control memory structure 118b may receive control messages to send a grade control message to either the host server/service 102 or the grading processor 124. The grade control memory structure 118b also receives a grade control message to store. The grade control message may be associated with a property information message. The grade control memory structure 118b may send a grade control message to the host server/service 102 or the grading processor 124 in response to a request, the specific grade control message sent being the grade control message associated with a property information message. The grade control memory structure 118b may also associate a grade time stamp with the grade control message, the grade time stamp being a time associated with when the grade control message has been determined or updated. The grade time stamp may be sent to the host server/service 102. The grade control memory structure 118b may associate a user message with credential, the credential being associated with a property information message.

The update timer 120 may receive an update time period message and the grade time stamp from the host server/service 102. The update timer 120 determines whether an update time period has elapsed based on the grade time stamp and the update time period message, the update time period message comprising information regarding the amount of time until a control message is sent to the host server/service 102. The update timer 120 may utilize an initial time indicator, such as the grade time stamp, and a counter to determine whether the update time period has elapsed. When the update time period has elapsed, the update timer 120 sends a control message to the host server/service 102, the control message may comprise instructions for the host server/service 102 to send a resource control message to receive external grading resources from the one or more external control memory structures 118a. An update time period message may have the same or different update time periods associated with the each of the one or more external control memory structures 118a and each external grading resources stored within the one or more external control memory structures 118a. These processes may be performed in accordance with Listing (11).

The change detector 122 receives a control message from the host server/service 102 and a control message from the one or more external control memory structures 118a. In response to the control message from the host server/service 102, the change detector 122 determine when a change occurs to the one or more external control memory structures 118a. The control message may instruct the change detector 122 to detect changes to one of more of the one or more external control memory structures 118a. In response receive a control message from one or more of the one or more external control memory structures 118a, the change detector 122 sends a control message to the host server/service 102 to request the associated external grading resources from the one or more external control memory structures 118a. These processes may be performed in accordance with Listing (111).

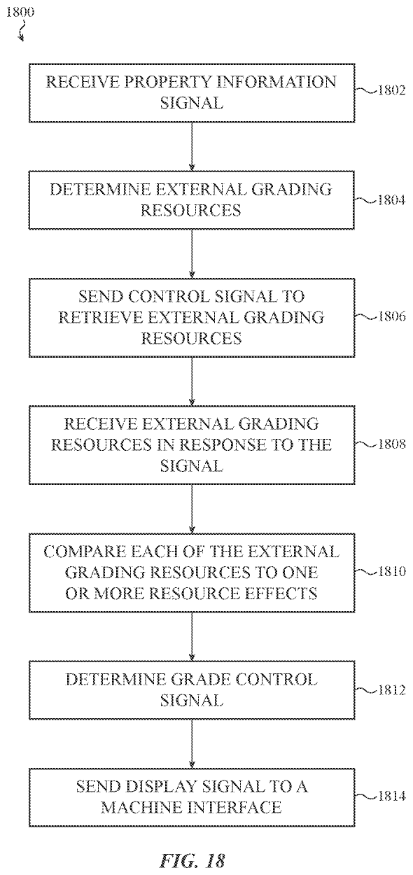

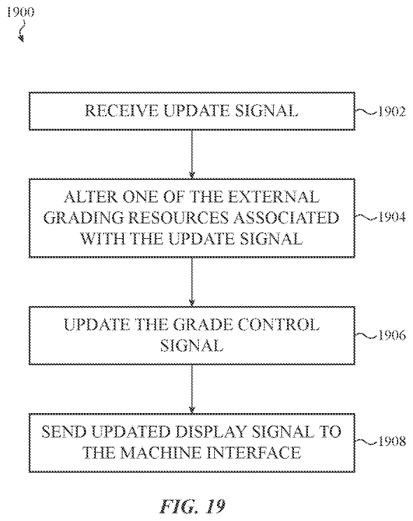

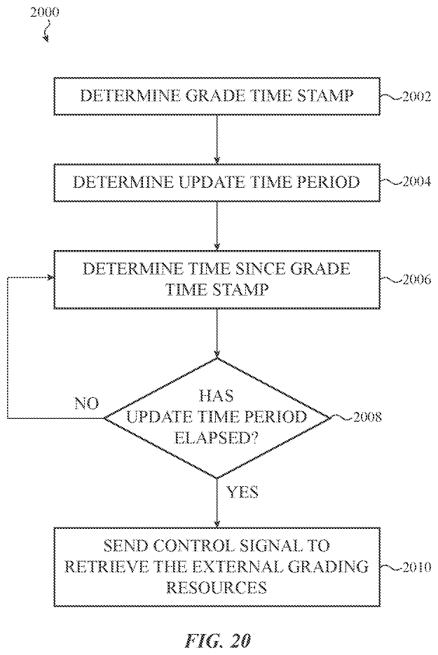

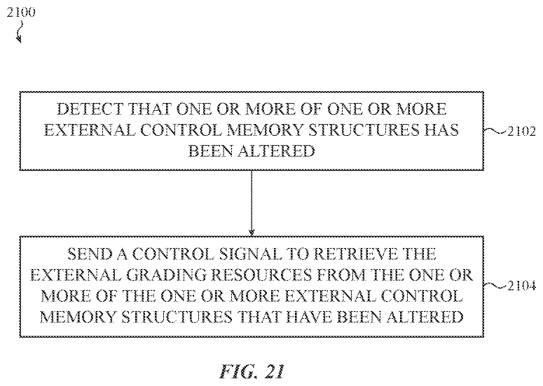

The asset grading system 100 may be operated in accordance with FIG. 18, FIG. 19, FIG. 20, and FIG. 21.

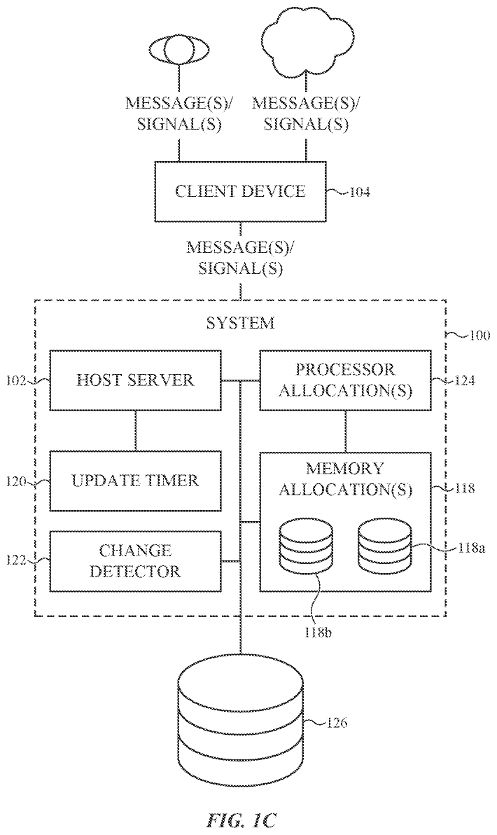

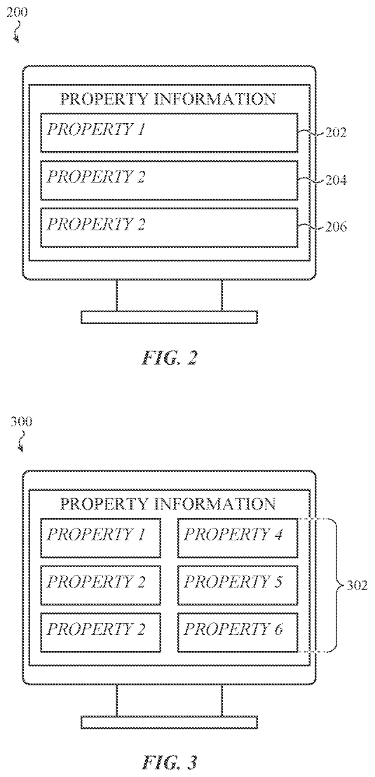

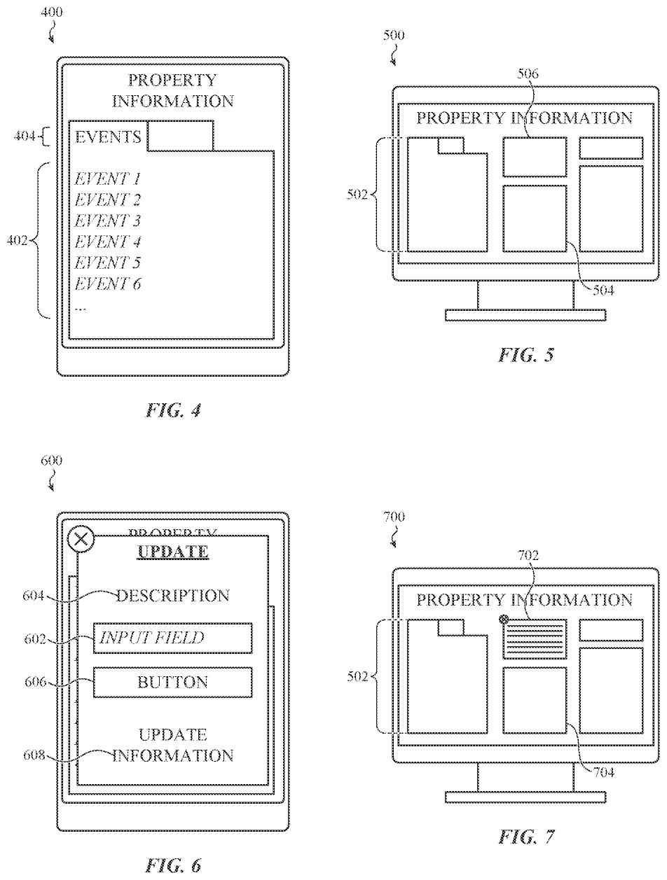

Referring to FIG. 2, a client device display 200 comprises a first property information message activation control 202, a second property information message activation control 204, and a third property information message activation control 206 oriented in a mobile-based browser display configuration. The client device display 200 may be displayed on the client device 104. Each property information message activation control may be associated with a property information message. An input device may be utilized to select a property information message activation control. Selecting one of the property information message activation controls sends the associated property information message to the machine controller. Selecting one of the property information message activation controls may also activate further controls on the client device display 200. The client device display 200 may display the properties associated with a user account via a user message. The property information message activation controls may alter the display to an interface, such as the interface depicted in FIG. 4.

Referring to FIG. 3, a client device display 300 comprises one or more property information message activation controls 302 oriented in a web-based browser display configuration. The client device display 300 may be displayed on the client device 104. Each of the property information message activation controls may be associated with a property information message. An input device may be utilized to select a property information message activation controls. Selecting one of the property information message activation controls sends the associated property information message to the machine controller. Selecting one of the property information message activation controls may also activate further controls on the client device display 300. The client device display 300 may display the properties associated with a user account via a user message. The property information message activation controls 302 may alter the display to an interface, such as the interface depicted in FIG. 5.

Referring to FIG. 4, a client device display 400 comprises display activation controls 402 and view activation controls 404 oriented in a mobile-based browser display configuration. The client device display 400 may be displayed on the client device 104.

The display activation controls 402 provide an indication of status of the major milestones (alternatively, “bubbles”) on a specific real estate closing associated with a property information message. The view activation controls 404 may be selected to alter the display to view further information. An input device may be utilized to select one of the display activation controls 402. In response more data may surface beneath offering more details as to ordered, received, needed states of bubble data. If the bubble is not applicable to a certain product, it will not be surfaced to the user. The displayed “bubbles” may be determined by the host server/service 102 and sent to the client device 104 via a display message. The host server/service 102 may utilize the grade control message in the grade control memory structure 118b associated with the property information message and the one or more resource effects in the resource effect control memory structure 126 to determine the “bubbles” displayed. Each of the display activation controls 402 may have a display indicator associated with it. For example, the green question marks may mean completed, red question marks may mean the user needs to provide information to the company for further processing, and the black question marks may mean in progress. Some display activation controls 402, such as those with a red question mark, may display an interface to receive an update message, as depicted in FIG. 6.

Referring to FIG. 5, a client device display 500 comprises display activation controls 502, a document list 504, and a property snapshot 506 oriented in a web-based browser display configuration. The client device display 500 may be displayed on the client device 104.

The display activation controls 502 provide an indication of status of the major milestones (alternatively, “bubbles”) on a specific real estate closing associated with a property information message. The document list 504 may comprise activators to add, view, and edit documents associated with a property information message. The property snapshot 506 may display information associated with the property information message.

An input device may be utilized to select one of the display activation controls 502. In response more data may surface beneath offering more details as to ordered, received, needed states of bubble data. If the bubble is not applicable to a certain product, it will not be surfaced to the user. The displayed “bubbles” may be determined by the host server/service 102 and sent to the client device 104 via a display message. The host server/service 102 may utilize the grade control message in the grade control memory structure 118b associated with the property information message and the one or more resource effects in the resource effect control memory structure 126 to determine the “bubbles” displayed. Each of the display activation controls 502 may have a display indicator associated with it. For example, the green check marks may mean completed, red exclamation points may mean the user needs to provide information to the company for further processing, and the black ellipses may mean in progress. Some display activation controls 502, such as those with a red exclamation point, may display an interface to receive an update message, as depicted in FIG. 7.

Referring to FIG. 6, the client device display 600 comprises an update message receiver 602, an update message descriptor 604, an update message activation control 606, and an update message history 608 oriented in a mobile-based browser display configuration. The client device display 600 may slide into the display of a client device from one or more edges of the client device or have an origin point from the one of the display activation controls 402 activated. The client device display 600 may then overlay the previous client device display. The client device display 600 may also partially overly the previous client device display, such as up to 10%, up to 20%, up to 30%, up to 40%, up to 50%, up to 60%, up to 70%, up to 80%, or up to 90%. The client device display 600 may be configured based on the display message received by the client device from the machine controller.

The update message receiver 602 may receive an update message. The update message may include audio, text, haptic inputs, files, etc. The update message descriptor 604 may comprise a description of the type of update message to be entered into the update message receiver 602. The update message activation control 606 may be utilized to have the client device 104 send the update message to the host server/service 102. The update message activation control 606 may receive audio, text, haptic inputs, etc. to operate. The update message history 608 may display a list of previous actions associated with the update message, as well as further information, such as date, time, and user of the action related to the update message.

Referring to FIG. 7, a client device display 700 comprises display activation controls 502, an update message descriptor 702, and an update message history 704 oriented in a web-based browser display configuration. The client device display 700 may alter the display of a client device when one of the display activation controls 502 is activated. The update message descriptor 702 may comprise a description of the type of update message associated with the selected on of the display activation controls 502. The update message history 704 may display a list of previous actions associated with the update message, as well as further information, such as date, time, and user of the action related to the update message.

Referring to FIG. 8, a client device display 800 comprises a display activation control history display 802 oriented in a mobile-based browser display configuration. The client device display 800 may slide into the display of a client device from one or more edges of the client device or have an origin point from the one of the display activation controls 402 activated. The client device display 800 may then overlay the previous client device display. The client device display 800 may also partially overly the previous client device display, such as up to 10%, up to 20%, up to 30%, up to 40%, up to 50%, up to 60%, up to 70%, up to 80%, or up to 90%. The display activation control history display 802 may be displayed based on the display message received by the client device from the machine controller. The display activation control history display 802 may depict a list of previous actions associated with the selected one of the display activation controls 402, as well as further information, such as date, time, and user of the action.

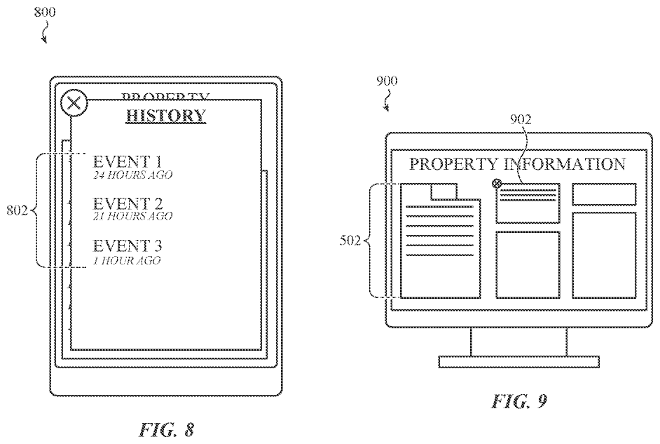

Referring to FIG. 9, a client device display 900 comprises display activation controls 502 and a display activation control history display 902 oriented in a web-based browser display configuration. The client device display 900 may alter the display of a client device when one of the display activation controls 502 is activated. The display activation control history display 902 may be displayed based on the display message received by the client device from the machine controller. The display activation control history display 902 may depict a list of previous actions associated with the selected one of the display activation controls 502, as well as further information, such as date, time, and user of the action.

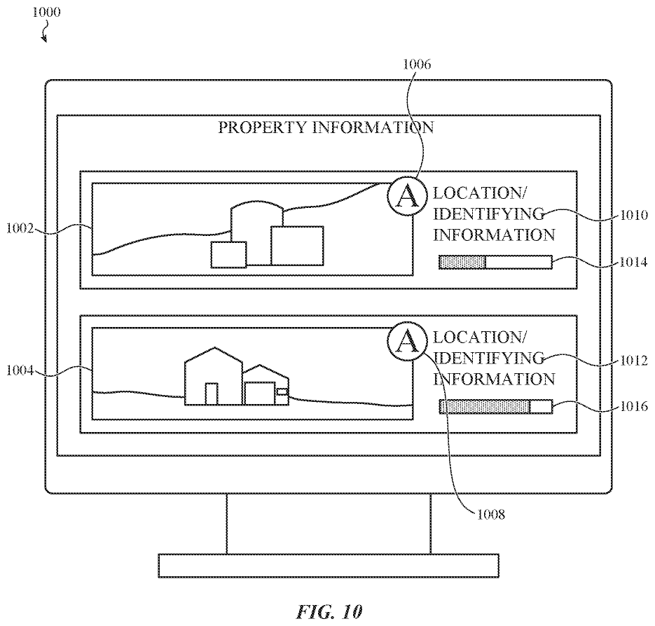

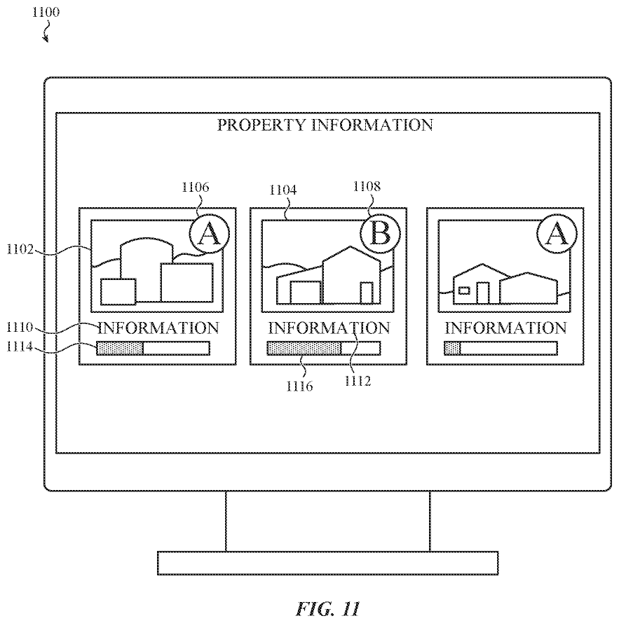

Referring to FIG. 10, a client device display 1000 comprises a first property information message activation control 1002, a second property information message activation control 1004, a first grade control message indicator 1006, a second grade control message indicator 1008, a first property information message indicator 1010, a second property information message indicator 1012, a first progress indicator 1014, and a second progress indicator 1016 oriented in a mobile-based browser display configuration. The client device display 1000 may be displayed on the client device 104.

Each property information message activation control may be associated with a property information message. An input device may be utilized to select a property information message activator. Selecting one of the property information message activator sends the associated property information message to the machine controller. Selecting one of the property information message property information message activation control may also activate further controls on the client device display 1000. For example, the client device display 400 may be displayed for the selected property information message activation control.

The client device display 1000 may display the properties associated with a user account via a user message. As depicted, the first property information message activation control 1002 is associated with the first grade control message indicator 1006, the first property information message indicator 1010, and the first progress indicator 1014. The first grade control message indicator 1006, the first property information message indicator 1010, and the first progress indicator 1014 may be associated with a property information message in a grade control memory structure and displayed as a result of the associated display message interacting with the client device 104. Furthermore, the second property information message activation control 1004 is associated with the second grade control message indicator 1008, the second property information message indicator 1012, and the second progress indicator 1016. The second grade control message indicator 1008, the second property information message indicator 1012, and the second progress indicator 1016 may be associated in the grade control memory structure and displayed as a result of the associated display message interacting with the client device 104.

Referring to FIG. 11, a client device display 1100 comprises a first property information message activation control 1102, a second property information message activation control 1104, a first grade control message indicator 1106, a second grade control message indicator 1108, a first property information message indicator 1110, a second property information message indicator 1112, a first progress indicator 1114, and a second progress indicator 1116 oriented in a web-based browser display configuration. The client device display 1100 may be displayed on the client device 104.

Each property information message property information message activation control may be associated with a property information message. An input device may be utilized to select a property information message property information message activation control. Selecting one of the property information message property information message activation control sends the associated property information message to the machine controller. Selecting one of the property information message activator may also activate further controls on the client device display 1100. For example, the client device display 500 may be displayed for the selected property information message activation control.

The client device display 1100 may display the properties associated with a user account via a user message. As depicted, the first property information message activation control 1102 is associated with the first grade control message indicator 1106, the first property information message indicator 1110, and the first progress indicator 1114. The first grade control message indicator 1106, the first property information message indicator 1110, and the first progress indicator 1114 may be associated with a property information message in a grade control memory structure and displayed as a result of the associated display message interacting with the client device 104. Furthermore, the second property information message activation control 1104 is associated with the second grade control message indicator 1108, the second property information message indicator 1112, and the second progress indicator 1116. The second grade control message indicator 1108, the second property information message indicator 1112, and the second progress indicator 1116 may be associated in the grade control memory structure and displayed as a result of the associated display message interacting with the client device 104.

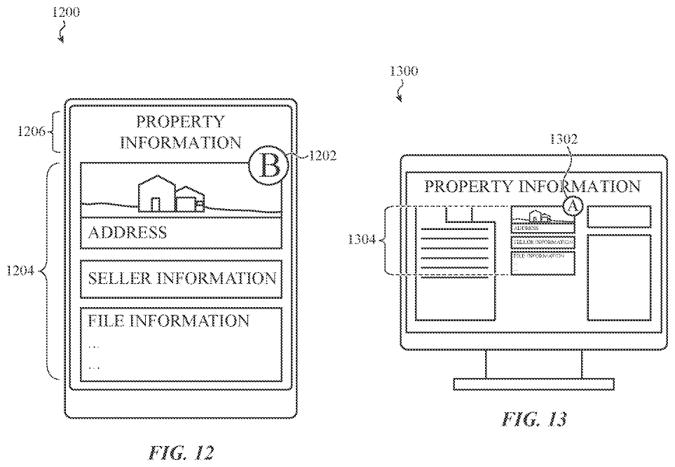

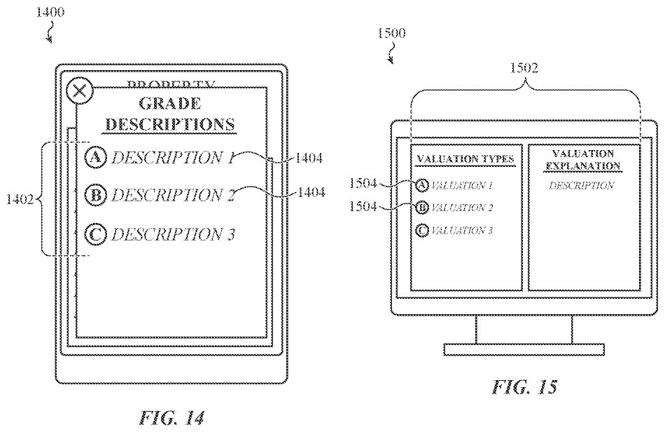

Referring to FIG. 12, the client device display 1200 comprises a grade control message indicator 1202, an enhanced property information message display 1204, and a view activation controls 1206 oriented in a mobile-based browser display configuration. The grade control message indicator 1202 may be associated with a property information message in a grade control memory structure and displayed as a result of the associated display message interacting with the client device 104. The grade control message indicator 1202 may further receive an input, the input activating a further display which may appear on the display via a fly-out surface(s). The further display is depicted in FIG. 14. The enhanced property information message display 1204 may be displayed as a result of the activation of a property information message activation control via the associated display message interacting with the client device 104. The additional information may be stored in the grade control memory structure. The view activation controls 1206 may be selected to alter the display to view further information.

Referring to FIG. 13, the client device display 1300 comprises a grade control message indicator 1302 and an enhanced property information message display 1304 oriented in a web-based browser display configuration. The grade control message indicator 1302 may be associated with a property information message in a grade control memory structure and displayed as a result of the associated display message interacting with the client device 104. The grade control message indicator 1302 may further receive an input, the input activating a further display which may appear on the display via a fly-out surface(s). The further display is depicted in FIG. 15. The enhanced property information message display 1304 may be displayed as a result of the activation of a property information message activation control via the associated display message interacting with the client device 104. The additional information may be stored in the grade control memory structure.

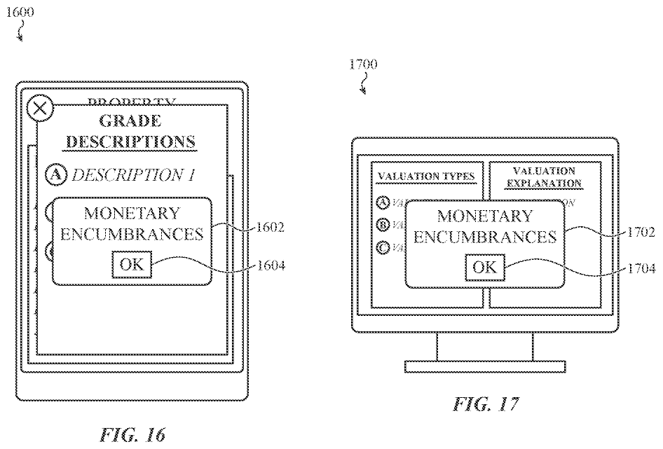

The client device display 1400 comprises a grade control message description 1402 and one or more definition activation controls 1404 oriented in a mobile-based browser display configuration. The grade control message description 1402 may display further information for each grade control message. The one or more definition activation controls 1404 may receive an input and in response alter the machine display to display further information regarding the selected definition of the one or more definition activation controls 1404. The one or more definition activation controls 1404 may be hyperlinks that activate a pop up display with the definition of the selected definition of the one or more definition activation controls 1404, such as that depicted in FIG. 16. The further information may be stored on a local device, such as the device comprising the client device. The information may also be stored in the resource effect control memory structure and retrieved via the input message.

The client device display 1500 comprises a grade control message description 1502 and one or more definition activation controls 1504 oriented in a web-based browser display configuration. The grade control message description 1502 may display further information for each grade control message. The one or more definition activation controls 1504 may receive an input and in response alter the machine display to display further information regarding the selected definition of the one or more definition activation controls 1504. The one or more definition activation controls 1504 may be hyperlinks that activate a pop up display with the definition of the selected definition of the one or more definition activation controls 1504, such as that depicted in FIG. 17. The further information may be stored on a local device, such as the device comprising the client device. The information may also be stored in the resource effect control memory structure and retrieved via the input message.

Referring to FIG. 16, the client device display 1600 comprises a selected definition display 1602 and a selected definition de-activation control 1604 oriented in a mobile-based browser display configuration. The selected definition display 1602 may be displayed in response to the activation of one of the one or more definition activation controls 1404. The content may be stored locally or in the resource effect control memory structure. The selected definition de-activation control 1604 may receive an input and in response alter the machine display to return to the client device display 1400.

Referring to FIG. 17, the client device display 1700 comprises a selected definition display 1702 and a selected definition de-activation control 1704 oriented in a web-based browser display configuration. The selected definition display 1702 may be displayed in response to the activation of one of the one or more definition activation controls 1504. The content may be stored locally or in the resource effect control memory structure. The selected definition de-activation control 1704 may receive an input and in response alter the machine display to return to the client device display 1500.

Referring to FIG. 18, the scoring method 1800 comprises receiving a property information message (block 1802) The property information message may comprise information for identifying a property, such as an address. The external grading resources are determined (block 1804). The external grading resources may be a predetermined list, may be determined dynamically based on previously received property information messages, or may be selected from the predetermined list based on factors such as location or determined trends. A control message is sent to retrieve external grading resources (block 1806). The external grading resources may be retrieved from the one or more external control memory structures. The external grading resources are retrieved in response to the message (block 1808). Each of the external grading resources is compared to one or more resource effects (block 1810). A grade control message is determined (block 1812). In some embodiments, the grade control message may be stored. A display message is sent to a client device (block 1814). The display message comprise instructions to display the grade control message. The display message may also comprise instructions to alter the client device to indicate the results of the comparison, as well as actions that may alter the comparison. The client device may be further altered to enable those actions to be performed via the client device.

Each of the external grading resources may be associated with one or more resource effects, which may be stored in a resource effect control memory structure. The external grading resources may include, but is not limited to: Lack of a right of access to and from the land; Defective Acknowledgment in Deed; Adverse Claim Disclosed; Proposed Seller or Borrower Does Not Have Title; Lacks Legal Capacity to Hold Title; Farm Credit System Institution Foreclosure of Deed of Trust; Farmland Foreclosure by or Deed in Lieu to Secretary of Agriculture; Farmland Homestead Property Acquired by Secretary of Agriculture; Bankruptcy Applies—Require Bankruptcy Documentation; Bankruptcy—Lift of Stay; Boundary Line Conflict—Requires Boundary Line; Condominium Assessments; Approval of Sale; Certificate of Completion; Proof of Payment of Assessments; Recorded Assessment Lien—Secure Release; First Refusal; Record Certified Copy; Authority of Church to Sell or Mortgage; Conveyance to Trustees of Church; Authority of Corporation; Corporate Charter Has Been Forfeited—Require; Corporate Restructure; Alien Corporation Authority; Corporation was Dissolved; Compliance with ARS Title 10; Corporation Revoked—Less than 6 Months; Proof of Forfeiture; Insuring the Contract—Review a Copy; Possible Outstanding Contracts; Requirement of Seller Consent to Transaction; Affidavit of Completion of Forfeiture; Review of Forfeiture Proceedings; Notice of Reinstatement; Tenancy by Entirety—Survivorship; Tenancy Survivorship; Pending Administration—Require Court Order; Require Administration and Authorization; Determine of Heirship if No Administration; Proof of Death—Joint Tenancy or Tenants by Entireties; Estate and Death Taxes; Recordation of Affidavit of Succession to Real Property; Record Certificate of Purchase—State Land; Record Certificate of Purchase with Assignment; Adequacy of the Deed in Lieu of Foreclosure; Release by Noninstituional Lender; Payoff of Credit Line; Foreclosure; Substantial Delay in Recording; Recording After the Grantor's Death; Defective Description; Record Copy of Divorce; Review Copy of Divorce; Require Deed; Release of Divorce Lien; Pending Divorce; Alimony Judgment; Child Support Order; Parties in Possession (1-4 Family); Parties in Possession (Commercial or Agricultural); Easements and Survey Matters; Easements and Survey Matters (Preferred Survey); Mechanic's Liens; Taxes and Assessments; Gift Tax Lien, if any; Federal Tax Lien—Nonjudicial Foreclosure; Require Release of Lien; Require Gap Indemnity; Satisfactory Evidence Required by Company; Court Approval of Transaction; Hospital Hill-Burton Funds; Proof of Death of Joint Tenant by Affidavit; Search of Names; Release of Judgments; Attachment; Writ of Execution; Proof that Lease Exists; Proof that Lease Ended; Insuring a New Lease; Application to Assign Lease; Record State Lease; Assignment of State Lease; Record Assigned State Lease; Landlord's Estoppel Affidavit; Life Estate—Proof Ended or Joinder; Release of Withdrawal of Lis Pendens and Suit; Require Suit Dismissal; Suit Not Examined; Persons Not Made Parties; Persons Served by Publication; Limited Liability Company Transaction Approval; Joinder of Spouse of Named Person; Joinder of Spouse of Current Owner; Require Marital Status of Current Owner; Require Marital Status of Named Person; Record Shows Owner is Married; Record Shows Owner is Married—Joinder in Mortgage; Name Change Because of Divorce Require Copy; Name Change Because of Marriage; Require Statutory Notice of Completion; Inspection to Determine No Commencement; Require Statutory Bond for Recorded Lien; Require Statutory Bond for Project; Require Release; Requirement for Notice to Order Inspection Prior to Close of Transaction; Requirement for Lien Waivers, Financial Statements, etc.; Proof That the Child is Still a Minor; Proof that 18 Years of Age in Current Transaction; Proof of Age in Prior Transaction; Require Guardian, Conservator, Representative; Verify Mobile Home is Attached and Taxes Paid; Payment of Personal Property Taxes; Payment of Lien of Certificate of Title; Surrender of Certificate of Title; Record Affidavit of Affixture; Recorded Affidavit of Affixture; Record Release of Lien by AA; Record Removal Affidavit; Require Release; Proof of Valid Foreclosure; Payoff of Equity Line Loan; Require Delivery of Release by Private Lender; Not Same Person Affidavit; Same Person Affidavit; Liens Against Proposed Grantee; Names of Lender or Purchaser; Affidavit of Identity; Identification and Marital status; Approved by The Secretary of Interior, BIA Report; Tribal Transaction; Require Release of Option; Authority of General Partnership Joint Venture; Authority of Limited Partnerships; Patent Required by Company; Satisfaction of Power of Attorney; Records Show that the Transaction was Executed; Power of Attorney did not Authorize the Transaction; Regulatory Approval; Require Release of Unrecorded Matters; Release of Repurchase/Refusal Rights; Release of Reversionary Clause; Affidavit that Survey is Still Correct; Update Prior Survey; Inspection is Required; Possible Retroactive Taxes; Payment of Prior Taxes; Tax Sale Require Deed from Last Record Owner; Delinquent Assessments; Pending Bankruptcy Against Owner; Copy of Trust; Liens Against Trustee; and Require Release of UCC. The machine controller may utilize machine-based learning to determine the one or more resource effects associated with the above list, including the combined effect of two or more of the above.

Referring to FIG. 19, the scoring update method 1900 comprises receiving an update message associated with the property information message (block 1902). The update message may be associated with a property information message. The update message may comprise instruction to associate with and alter one or more of the external grading resources. The associated one of the external grading resources is altered (block 1904). The grade control message is updated in response (block 1906). The previously determined grade control message and associated one or more resource effects may be utilized along with the updated one of the external grading resources. The updated external grading resources are compared to the one or more resource effects, resulting in an updated grade control message. An updated display message is sent to the client device (block 1908). The updated display message may comprise instructions for the client device to display the updated grade control message. The updated display message may also comprise instructions to alter the client device to indicate the results of the comparison, as well as actions that may alter the comparison. The client device may be further altered to enable those actions to be performed via the client device.

Referring to FIG. 20, the timed update method 2000 determines a grade time stamp (block 2002). The grade time stamp may be determined when the grade control message is determined. An update time period is determined (block 2004). Trends based on location, events, and individuals may be utilized to determine an update time period to efficiently update the grade control message. The update time period may also be pre-determined or input via the client device utilizing a property information message, user message, or update message. The time elapsed since the grade time stamp is determined (block 2006). A counter may be utilized to determine the time elapsed since the grade time stamp. Whether the update time period has elapsed is determined (decision block 2008). If the update time period has not elapsed, the time since the grade time stamp is continued to be determined. If the update time period has elapsed, a control message is sent to retrieve the external grading resources (block 2010).

Referring to FIG. 21, the detected update method 2100 detects that one or more of one or more external control memory structures has been altered (block 2102). Metadata of the external grading resources stored in the one or more external control memory structures, such as version or date of last update, may be detected to indicate that an alteration has been made. A control message is sent to retrieve the external grading resources from the one or more of the one or more external control memory structures that have been altered in response to detecting that the one or more of the one or more external control memory structures (block 2104).

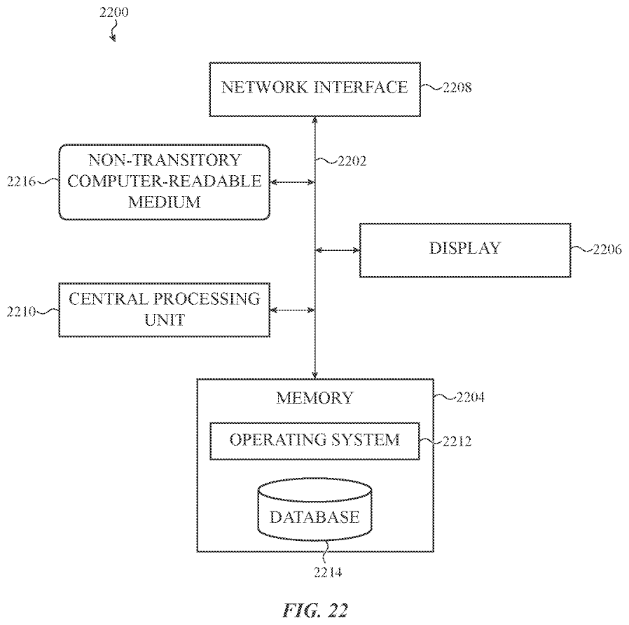

FIG. 22 illustrates several components of an example system 2200 in accordance with one embodiment. In various embodiments, system 2200 may include a desktop PC, server, workstation, mobile phone, laptop, tablet, set-top box, appliance, or other computing device that is capable of performing operations such as those described herein. In some embodiments, system 2200 may include many more components than those shown in FIG. 22. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 2200 may comprise one or more physical and/or logical devices that collectively provide the functionalities described herein. In some embodiments, system 2200 may comprise one or more replicated and/or distributed physical or logical devices.

In some embodiments, system 2200 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 2200 includes a bus 2202 interconnecting several components including a network interface 2208, a display 2206, a central processing unit 2210, and a memory 2204.

Memory 2204 generally comprises a random access memory (“RAM”) and permanent non-transitory mass storage device, such as a hard disk drive or solid-state drive. Memory 2204 stores an operating system 2212.

These and other software components may be loaded into memory 2204 of system 2200 using a drive mechanism (not shown) associated with a non-transitory computer-readable medium 2216, such as a floppy disc, tape, DVD/CD-ROM drive, memory card, or the like.

Memory 2204 also includes database 2214. In some embodiments, system 2200 may communicate with database 2214 via network interface 2208, a storage area network (“SAN”), a high-speed serial bus, and/or via the other suitable communication technology.

In some embodiments, database 2214 may comprise one or more storage resources provisioned from a “cloud storage” provider, for example, Amazon Simple Storage Service (“Amazon $3”), provided by Amazon.com, Inc. of Seattle, Wash., Google Cloud Storage, provided by Google, Inc. of Mountain View, Calif., and the like.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, a compare or comparison may be carried out by a “comparator”, and so on.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Comparator” in this context refers to a logic element that compares two or more inputs to produce one or more outputs that reflects similarity or difference of the inputs. An example of a hardware comparator is an operational amplifier that outputs a message indicating whether one input is greater, less than, or about equal to the other. An example software or firmware comparator is: if (input1==input2) output=val1; else if (input1>input2) output=val2; else output=val3; Many other examples of comparators will be evident to those of skill in the art, without undo experimentation.

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural messages, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure messages or software per se (however does not exclude machine memories comprising software and thereby forming configurations of matter).

“Software” in this context refers to logic implemented as processor-executable instructions in a machine memory (e.g. read/write volatile or nonvolatile memory or media).

“Change detector” in this context refers to a device operated by logic that determines whether a control memory structure has been altered and sends a control message to another device in response. The change detector may be further configured to detect changes for specific stored information in a control memory structure.

“Credential” in this context refers to tokens, passwords and PINs, public-keys, symmetric-keys, SMS-based authentication, biometric authentication, digital identity authentication, etc.

“External grading resources” in this context refers to stored control messages within one or more external control memory structures representing a physical, legal, etc. status.

“Grade control memory structure” in this context refers to a structure to store controls messages to associate property information messages, grade control messages, and credentials.

“Grading control memory structure” in this context refers to define

“Grading processor” in this context refers to a device operating logic to receive external grading resources, resource effects, and stored grade control messages, send control messages to retrieve stored grade control messages, retrieve resource effects associated with the external grading resources, transform the resource effects associated with the external grading resources into a grade control message, and sends the grade control message to a grade control memory structure.

“One or more resource effects” in this context refers to values, such as a numerical or alphabetic value, associated with a physical, legal, etc. status of an external grading resources.

“Property information message” in this context refers to a control message associated with a physical location, which may include information such as address, GPS coordinates, etc. to determine a specific property.

“Signal” in this context refers to one or more energy impulses that convey control commands, data, or attributes between machine elements or between people, or a combination of machines and people. Any physical entity exhibiting variation in time or variation in space is potentially a message. Examples of messages include electrical impulses such as analog or binary electrical phenomenon, audio, video, speech, image, communication, geophysical, sonar, radar, and musical messages.

“Update message receiver” in this context refers to a portion of a client device configured to receive an input, such as audio, text, haptic inputs, files, etc., to be associated with a property information message.

It is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

Accordingly, one may appreciate that although many embodiments are disclosed above, that the operations and steps presented with respect to methods and techniques described herein are meant as example and accordingly are not exhaustive. One may further appreciate that alternate step order or fewer or additional operations may be required or desired for particular embodiments.

Although the disclosure above is described in terms of various example embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described example embodiments but is instead defined by the claims herein presented.

1. A system comprising:
a host server executing an instance of a host service, the host service configured to:
receive, as input, an asset identifier from a client application, the asset identifier associated with a property;
receive, as input from a plurality of external grading resources, two or more data structures each associated with a respective resource effect, each resource effect comprising a value corresponding to one of a legal status of a physical status of the property;
determine a grade of the property based on a weighted average of each received value of each received data structure;
modify the grade based on a count of resource effects associated with a lowest value among all received values;
storing a timestamp at which the grade was calculated;
scheduling, based on the timestamp, a time at which the grade should be automatically updated with updated data from each of the plurality of external grading resources to an updated grade;
provide, as output, the grade to the client application; and
provide, as output, the updated grade to the client application; and
an electronic device comprising:
a display configured to render a graphical user interface;
a memory storing executable instructions; and
a processor operably coupled to the memory and configured to access the memory to instantiate a client application at least partially defining the graphical user interface and configured to:
receive an input from a user of the electronic device via the graphical user interface the input comprising a geographic area;
communicably couple to the host service;
render, in the graphical user interface, a set of images, each image associated with a gradable asset within the geographic area;
transmit, by the client application to the host service, an asset identifier associated with an image rendered in the graphical user interface;
in response to transmitting the asset identifier, receive from the host service, first structured data comprising a grade determined by the host service as specific to the asset identifier,
modify at least a portion of the graphical user interface to display the grade overlaying at least a portion of the image when the image is rendered in the current view of the graphical user interface; and
receive, from the host service, second structured data comprising an updated grade and, in response, modify at least a portion of the graphical user interface to display the updated grade overlaying at least a portion of the image when the image is rendered in the current view of the graphical user interface.

2. The electronic device of claim 1, wherein:
the graphical user interface is configured to:
display each of the set of images; and
receive from the host service a set of gradings, each grading displayed at least partially adjacent to a respective one image of the set of images.

3. The electronic device of the system of claim 1, wherein the grade is based on an aggregation of data performed by the host service.

4. The electronic device of the system of claim 1, wherein the property is a real property.

5. The electronic device of the system of claim 1, wherein the image has a rectangular shape and the grade is displayed relative to a corner of the image.

6. The host service of the system of claim 1, wherein:
the property is a real property; and
the grade is calculated based, at least in part, on a number of encumbrances on a title to the property.

7. The host service of the system of claim 6, wherein the grading is based at least in part, on a number of active leases of the real property.

8. The host service of the system of claim 7, wherein the grading is based at least in part, on a term of at least one lease of the number of active leases.

9-15. (canceled)
